(19) United States
(12) Patent Application Publication
(10) Pub. No.: US 2012/0208041 A1
(43) Pub. Date: Aug. 16, 2012

(54) TEARDROP LATTICE STRUCTURE FOR HIGH SPECIFIC STRENGTH MATERIALS

(75) Inventor: Jay Clarke Hanan, Sand Springs, OK (US)

(73) Assignee: THE BOARD OF REGENTS FOR OKLAHOMA STATE UNIVERSITY, Stillwater, OK (US)

(21) Appl. No.: 13/502,963

(22) PCT Filed: Oct. 27, 2010
(86) PCT No.: PCT/US2010/054305

§ 371 Date: Apr. 19, 2012

Related U.S. Application Data
(60) Provisional application No. 61/255,303, filed on Oct. 27, 2009.

(51) Int. Cl. B32B 3/12; B32B 15/01; B21D 31/00; B32B 7/14

(52) U.S. Cl. 428/593; 428/595; 428/178; 72/379.2

(57) ABSTRACT

A continuous segment of metallic glass material having a thickness substantially less than a width is disclosed. The continuous strip is bent into a repeating pattern of a teardrop shape providing an outer radius and an inner point defined by two adjacent radii.

### CROSS REFERENCE TO RELATED APPLICATIONS

This application claims the priority of U.S. Provisional Patent Application No. 61/255,303 entitled “TEARDROP LATTICE STRUCTURE FOR HIGH SPECIFIC STRENGTH MATERIALS,” filed Oct. 27, 2009, the contents of which are hereby incorporated by reference.

### STATEMENT REGARDING FEDERALLY SPONSORED RESEARCH OR DEVELOPMENT

This invention was made with government support under ONR Grant No. N00173-07-1-G001 awarded by the Office of Naval Research. The government has certain rights in the invention.

### FIELD OF THE INVENTION

This disclosure relates to high strength materials in general and, more specifically, to lattice structured high strength materials.

### BACKGROUND OF THE INVENTION

Honeycombed or lattice structures may be manufactured based on cellular arrangements of known materials. Depending upon the constituent material and the method of producing the structure, desired properties such as load bearing ability and elasticity can be achieved. However, new materials, or those not previously used in developing cellular structures provide new challenges in determining the best way to exploit the inherent advantages and properties of certain materials.

What is needed is a system and method for addressing this, and related, issues.

### SUMMARY OF THE INVENTION

The invention of the present disclosure as described and claimed herein, in one aspect thereof, comprises a continuous segment of metallic glass material having a thickness substantially less than a width. The continuous strip is bent into a repeating pattern of a teardrop shape providing an outer radius and an inner point defined by two adjacent radii. In some embodiments, the adjacent radii are joined by an adhesive. In other embodiments, the adjacent radii are joined by laser welding.

In some embodiments, the metallic glass material further comprises an alloy of iron, nickel, and molybdenum. A second continuous strip of metallic glass may be bent into a repeating pattern and affixed to the first.

The invention of the present disclosure as described and claimed herein, in another aspect thereof, comprises a method of constructing a cellular lattice structure. The method includes providing a length of metallic glass alloy, bending the length of metallic glass alloy into a repeating pattern forming a plurality of cells, and fixing the length of metallic glass alloy into the repeating pattern by affixing the alloy to itself along cell borders. The length of metallic glass alloy may be fixed by an adhesive, or may be laser welded.

In one embodiment, bending the metallic glass alloy comprises bending the metallic glass alloy into a repeating tear drop pattern having an outer radii and inner point, wherein the inner point is formed by the outer radii of adjacent cells. Providing a length of metallic glass alloy may further comprise providing an alloy comprising iron, nickel, and molybdenum with a thickness substantially less than a width, said alloy being able to substantially avoid plastic deformation during bending.

### BRIEF DESCRIPTION OF THE DRAWINGS

FIG. 1 is a perspective view of segment of a lattice teardrop structure according to aspects of the present disclosure.

FIG. 2 is a top down view of a multilayered structure of teardrop lattice.

FIG. 3 is a top down view of a device for manufacturing teardrop lattice segments in an first, open configuration.

FIG. 4 is a top down view of the device of FIG. 3 in a second, closed position.

FIG. 5 illustrates a portion of the device of FIG. 3 showing how the completed lattice teardrop segment is removed from the device.

### DETAILED DESCRIPTION

Metallic glass refers to a class of materials with an amorphous structure. They are often iron-nickel based alloys with lesser amounts of boron, molybdenum, silicon, carbon or phosphorous. They are made by abrupt quenching from the melt before the structure can crystallize. Their excellent magnetic properties allows them to find applications in fields such as electrical power, electronics, transduction and metal joining industries. They also posses good mechanical properties such as a yield strength of >3 GPa, which makes them potential candidates in load bearing applications.

The mechanical behavior of a structured material depends not only on the type and strength of constituent material that is used to build the structure, but also greatly depends on the geometry of the internal structure. Structural efficiency can be achieved by altering the shape factor in the microscopic as well as the macroscopic scale. A change in the material geometry impacts properties such as density, strength, and modulus.

Honeycombs are light weight cellular materials which have periodic arrangement of cells, walls of which support an applied load. High energy absorption characteristics, and a high strength to weight ratio of honeycombs finds various applications ranging from cushioning materials in packages to sandwich panels in aircraft. Metallic and non-metallic honeycombs exists for various applications. Most common manmade honeycomb structures are expanded aluminum honeycombs. Other classes of manmade honeycombs such as Aramid reinforced honeycombs, fiber glass reinforced honeycombs, and polyurethane honeycombs are also available.

### Manufacturing Methods of Honeycomb Structures

Most high mechanical efficiency honeycomb structures are made using the expansion method where sheets of the base material from a web is cut into sheets of desired sizes, a high strength adhesive is applied on the face of the sheets in a staggered manner, and the sheets are stacked together until the adhesive is cured. Those layers can be cut into desired thickness and expanded to form honeycomb structures. Other conventional manufacturing methods used to make honeycombs include using a corrugated press where the material is corrugated using a gear press to form the desired shape. The corrugated sheets are then stacked together either using adhesives or by welding techniques. Both of these require plastic deformation of the constituent metal.

Other available methods for manufacturing honeycombs include assembling slotted metal strips (brittle honeycombs such as ceramic and some composite honeycombs are made using this method). Other methods such as investment casting, perforated metal sheet forming and wire/tube layup technique can also be used to manufacture lattice truss structures.

In order to make honeycombs out of amorphous metallic glass, the methods of the present disclosure have been developed. In various embodiments, these methods entail a bottom-up approach that differs from prior honeycomb processing methods.

Metallic Glass alloy used for first prototype: MB2826

In one embodiment of the present disclosure, MB2826 is utilized as the base material for a high strength structure. MB2826 is an iron-nickel-molybdenum based metallic glass (MG) alloy. It possesses excellent magnetic properties and has long found application in transformer cores. In one embodiment used with the present disclosure, the material is slip cast into thin metallic strips of about 28 μm in thickness and about 8 mm wide. MB2826 ribbon was chosen for one embodiment and for testing. However, it is understood that other MG alloys may be utilized in different embodiments.

As can be seen in Table 1 below, MB2826 metallic glass alloy possess superior mechanical properties when compared to that of Aluminum 5052, which is another material used for making honeycombs.

TABLE 1

| | Properties | | |
|---|---|---|---|
| | Yield Strength | Elastic Modulus | Elastic Strain |
| Material | (GPa) | (GPa) | Limit |
| Metallic Glass alloy | 1.9-2.7 | 100-110 | 2.0% |
| (MB2826) | | | |
| Aluminum 5052 | 0.2 | 70 | 0.4% |

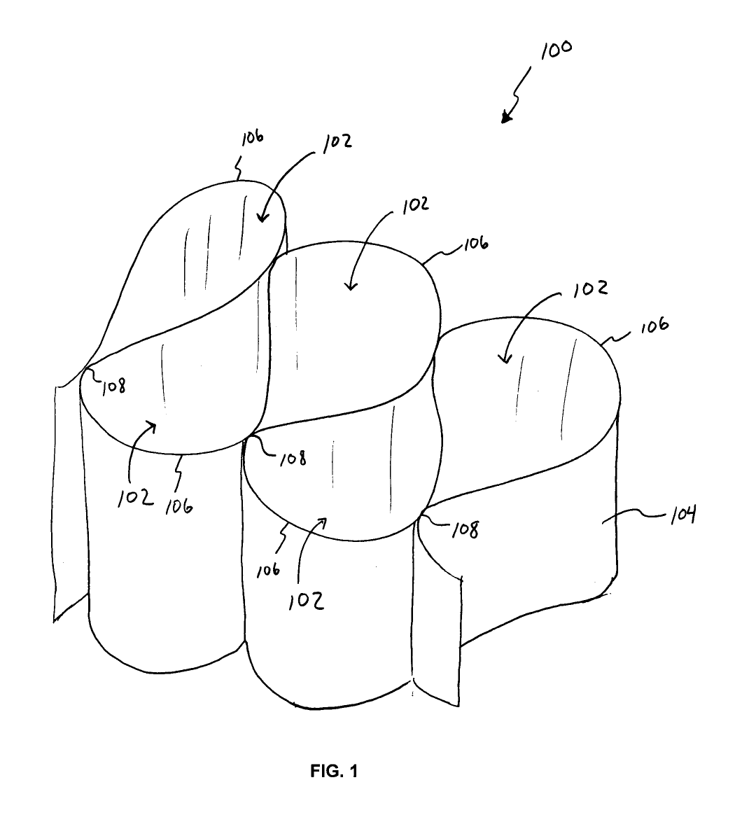

Referring now to FIG. 1, a perspective view of a segment of a lattice teardrop structure 100 according to aspects of the present disclosure is shown. In the present embodiment, a plurality of continuous teardrop shaped cells 102 are formed from a continuous strip of MB2826 104. The continuous strip 104 forms a substantially rounded radius 106 that contacts a neighboring radius in a competing pattern. The cells 106 form an apex or point 108 where they contact. This forms a repeating pattern of teardrop shaped cells rather than honeycombed, square, or another shape. The contact points 108 may be fused together or attached by an adhesive as explained below.

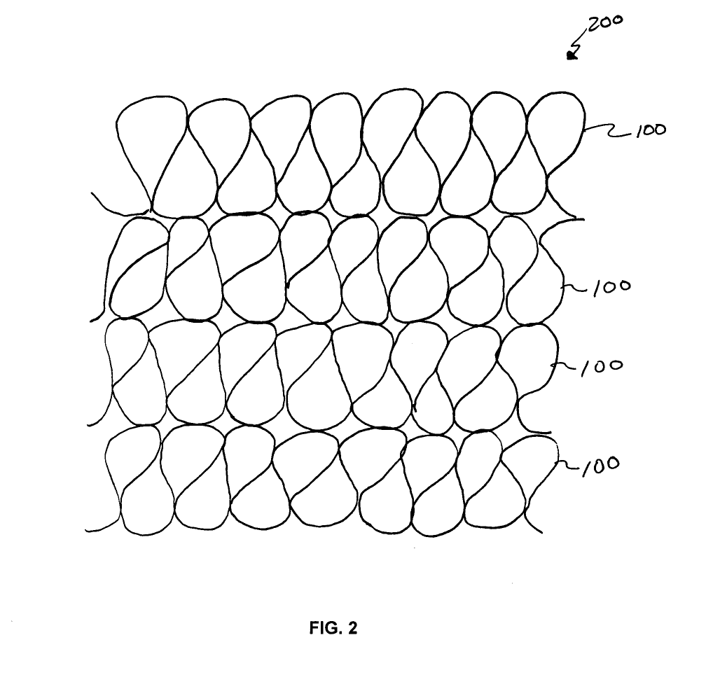

Referring now to FIG. 2, a top down view of a multilayered structure 200 of teardrop lattice is shown. Structures such as these may be formed by superposition of the repeating lattice structures 100. Once again, the structures 100 may be fused or adhered to one another to form the structure 200.

### Exemplary Manufacturing Method for Making “Teardrop” Shaped MG Honeycombs:

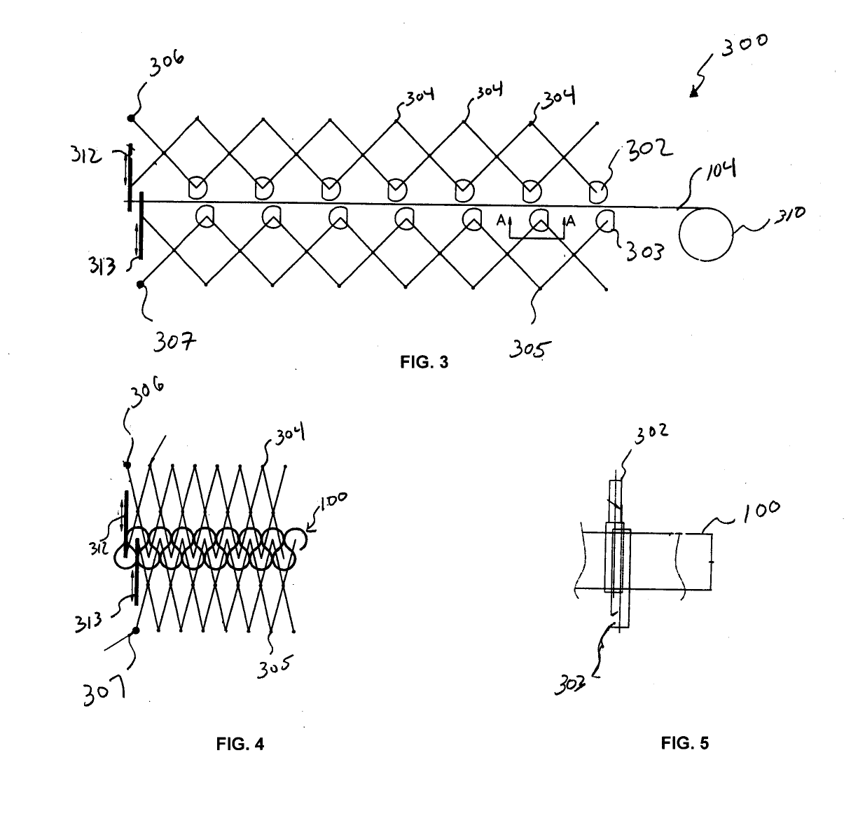

The high elastic limit of metallic glass alloys can be taken advantage of in making teardrop shaped honeycomb structures. The metallic glass ribbon 100 can be shaped using a tool as shown in FIG. 3. The strip 100 can be alternatively bonded using an adhesive to form cells 102 in the shape of teardrop.

The honeycomb structure 100 as a whole is manufactured by starting from a single cell. Using an epoxy based adhesive system and by inducing an area constraint, the MG alloy 104 can be curved and bonded to its surface to form a cell 102 in the shape of a teardrop. Other forms of precision bonding techniques such as laser welding and electron beam welding can be employed for the same, provided they do not embrittle the alloy 104. Lattice rows 100 of desired lengths can be made and can be bonded together to form a complete “Teardrop” metallic glass honeycomb plate 200 as shown in FIG. 2.

The device 300 of FIG. 3 begins with the MG alloy 104 spooling off a single spool 310. The strip 104 is fed between a first set of pins 302 and a second set of pins 303. The pin sets 302, 303 are movably mounted onto moveable hinges 304, 305, respectively. First and second sliding actuators 312, 313 actuate the pin and hinge system in an accordion-like fashion. This movement cause the pins 302, 304 to contact the strip 104, bending it into the aforedescribed repeating teardrop configuration. The device 300 is shown in a collapsed configuration in FIG. 4.

The strip 104 is now formed into the teardrop lattice structure 100. As mentioned, adhesives may be used to ensure that the structure 100 retains its shape. In other embodiments, laser welding or other means may be utilized to secure the structure 100 into shape.

Referring now to FIG. 5, a portion of the device 300 is shown. Here a first pin 302 is shown against a second pin 303. The pins 302 and 303 may be mounted from opposing directions. This allows the structure 100 to be removed from the device 300 without damage.

As with honeycombs, these new “teardrop” (TD) shaped MG honeycombs 100 are most effective and have superior mechanical properties in the out-of-plane direction. The in plane properties are also of interest for high compliance applications. The mechanical properties of the TD-MG honeycombs 100 can be predicted using the parent material properties.

In one analysis, by approximating the cells 102 of the “teardrop” shaped MG honeycombs 100 to be in the shape of hexagons, the compressive mechanical properties of the TD-MG honeycombs can be predicted. The predictions in table 2 below show comparable performance to aluminum honeycombs for our an MG ribbon based prototype, and suggest a two to four times improvement over aluminum honeycombs would be expected with Fe based BMG alloys.

TABLE 2
Measured properties in the early prototype

| | Material | | | |
|---|---|---|---|---|
| | “Teardrop” | “Teardrop” | “Teardrop” | |
| | shaped | shaped | shaped | |
| Property in the | Metallic Glass | Metallic Glass | Metallic Glass | Aluminum |
| out-of-plan (X₃) | Honeycombs | Honeycombs | Honeycombs | Honeycombs |
| direction | (t/l = 0.009) | (t/l = 0.01) [1] | (t/l = 0.05) [1] | (5052)* [2] |
| Density (g/cc) | 0.16 | 0.16 | 0.16 | 0.13 |
| Collapse Stress (MPa) | 5.4 | 6.1 | 8.9 | 9.6 |
| Young's Modulus (GPa) | 1.5 | 1.7 | 8.4 | 1.6 |
| Specific Strength | 34 | 38 | 55 | 96 |
| Densification Strain^{†} (mm/mm) | 0.9 | 0.9 | 0.9 | 0.7 |
| Energy absorption^{‡} (J/mm³) | 4.8 | 5 | 7.6 | 6.7 |

*Properties of Aluminum Honeycomb correspond to that of AI5052 honeycomb from PLASCORE with the highest tensile strength. †Densification Strain values approximated from compression tests on TD-MG and Aluminum Honeycombs. ‡Energy absorption calculated by approximating the area under the stress-strain curve in the X3 direction.

The (t/1) ratio of the TD-MG honeycombs that was considered for approximation is 0.01. By improving the method of manufacturing of the TD structures, by eliminating the flaws in the in alignment of the cells, and by stable and stronger bonding means; a reduction of 2× can be achieved in the cell size of the structure, which in turn increases the value of (t/1). Therefore, there will be significant increase in properties of strength and stiffness. This is easily done with automated manufacturing.

The high densification strain value of the TD-MG honeycombs adds to improved energy absorption characteristics.

It will be appreciate that a non-exhaustive list of properties of the MG honeycomb structure disclosed herein include: low density and light weight; high specific strength (high strength to weight ratio); greater energy absorption characteristics for its high value of strength and densification strain; high impact strength; and enhanced mechanical properties due to the high yield stress value of the MG alloy.

A non-exhaustive list of potential applications of the MG honeycomb structures disclosed herein include: energy absorbers in composite body armor; aerospace structure such as aircraft sandwich panels; automotive crashing test barriers; doors, ceilings and room panels; and passenger protective equipment in automobiles.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

### REFERENCES

[1] Properties of specific strength and Modulus calculated from “Cellular Solids” by Ashby considering double cell wall thickness.
[2] Mechanical Properties of Aluminum Honeycombs referred from www.plascore.com (3/160.003-5052).
[3] Tensile tests on Metallic Glass ribbons.

What is claimed is:

1. A structure comprising:
a continuous segment of metallic glass material having a thickness substantially less than a width;
wherein the continuous strip is bent into a repeating pattern of a teardrop shape providing an outer radius and an inner point defined by two adjacent radii.

2. The structure of claim 1, wherein the adjacent radii are joined by an adhesive.

3. The structure of claim 1, wherein the adjacent radii are joined by laser welding.

4. The structure of claim 1, where in the metallic glass material further comprises an alloy of iron, nickel, and molybdenum.

5. The structure of claim 1, further comprising a second continuous strip of metallic glass bent into a repeating pattern and affixed to the first.

6. A lattice structure comprising:
a first strip of metallic glass alloy formed into a repeating teardrop pattern with bends having outer radii in contact with one another forming a point;
wherein the metallic glass alloy strip is attached to itself along the points where the outer radii contact; and
wherein the metallic glass alloy strip experiences substantially no plastic deformation.

7. The lattice structure of claim 6, further comprising:
a second strip of metallic glass alloy formed into a repeating teardrop pattern with bends having outer radii in contact with one another forming a point;
wherein the second strip is in contact with the first strip along adjacent outer radii.

8. The lattice structure of claim 6, wherein the outer radii in contact with one another are affixed with an adhesive.

9. The lattice structure of claim 6, wherein the outer radii in contact with one another are laser welded together.

10. The lattice structure of claim 6, wherein the metallic glass alloy comprises iron, nickel, and molybdenum.

11. A method of constructing a cellular lattice structure comprising:
providing a length of metallic glass alloy;
bending the length of metallic glass alloy into a repeating pattern forming a plurality of cells; and
fixing the length of metallic glass alloy into the repeating pattern by affixing the alloy to itself along cell borders.

12. The method of claim 11, wherein bending the metallic glass alloy comprises bending the metallic glass alloy into a repeating tear drop pattern having an outer radii and inner point, wherein the inner point is formed by the outer radii of adjacent cells.

13. The method of claim 11, wherein the length of metallic glass alloy is fixed by an adhesive.

14. The method of claim 11, wherein the length of metallic glass alloy is fixed by laser welding.

15. The method of claim 11, wherein providing a length of metallic glass alloy further comprises providing an alloy comprising iron, nickel, and molybdenum with a thickness substantially less than a width, said alloy being able to substantially avoid plastic deformation during bending.
